(19) United States
(12) Patent Application Publication
(10) Pub. No.: US 2008/0304880 A1
(43) Pub. Date: Dec. 11, 2008

(54) TRANSFER APPARATUS AND IMAGE FORMING APPARATUS HAVING THE SAME

(75) Inventor: Seung-gweon Lee, Suwon-si (KR)

Correspondence Address: STANZIONE & KIM, LLP, 919 18TH STREET, N.W., SUITE 440, WASHINGTON, DC, 20006, US

(73) Assignee: Samsung Electronics Co., Ltd, Suwon-si (KR)

(21) Appl. No.: 11/970,765

(22) Filed: Jan. 8, 2008

(30) Foreign Application Priority Data
Jun. 7, 2007 (KR) 2007-55657

(51) Int. Cl. B41J 15/16

(52) U.S. Cl. 399/313

(57) ABSTRACT

A transfer apparatus for an image forming apparatus includes a transfer tube to face an image carrier, and a transfer roller disposed inside the transfer tube to cause the transfer tube to rotate.

### CROSS-REFERENCE TO RELATED APPLICATIONS

This application claims priority under 35 U.S.C. §119(a) from Korean Patent Application No. 2007-55657 filed Jun. 7, 2007 in the Korean Intellectual Property Office, the disclosure of which is incorporated herein by reference in its entirety.

### BACKGROUND OF THE INVENTION

1. Field of the Invention

The present general inventive concept relates to an image forming apparatus. More particularly, the present general inventive concept relates to a transfer apparatus usable with an image forming apparatus.

2. Description of the Related Art

Generally, an electro photographic image forming apparatus forms an image on an image carrier such as a photosensitive drum, and then, transfers the image formed on the image carrier onto a printing medium using a transfer apparatus to perform a printing operation.

FIG. 1 is a sectional view schematically illustrating a conventional transfer apparatus of an image forming apparatus.

Referring to FIG. 1, the conventional transfer apparatus of the image forming apparatus includes an image carrier 5 and a transfer roller 1.

The transfer roller 1 is rotatably disposed under the image carrier 5. A printing medium 7 passes between the transfer roller 1 and the image carrier 5. Also, a voltage applying portion 3 is connected to the transfer roller 1 to apply a voltage opposite to a polarity of toner to the transfer roller 1.

Therefore, a toner image formed on the image carrier 5 is transferred onto the printing medium 7 passing between the image carrier 5 and the transfer roller 1 in a transfer area F between the image carrier 5 and the transfer roller 1 by the voltage being applied to the transfer roller 1.

The printing medium 7 having the toner image transferred thereon moves to a fixing unit (not illustrated). The fixing unit fixes the transferred toner image onto the printing medium 7, and then the printing medium 7 having the toner image fixed thereon is discharged outside the image forming apparatus.

However, as illustrated in FIG. 1, there are two gaps S1 and S2 in front of and behind the transfer area F between the image carrier 5 and the transfer roller 1. Electrical discharge occurs in the two gaps S1 and S2 due to the transfer voltage being applied to the transfer roller 1. The two gaps S1 and S2 in front of and behind the transfer area F between the transfer roller 1 and the image carrier 5 refer to electrical discharge occurring areas in which the electrical discharge is generated by the transfer voltage.

A pre-transfer phenomenon occurs in a first electrical discharge occurring area S1 located upstream the transfer area F in a moving direction of the printing medium 7 (arrow B). The pre-transfer phenomenon represents toner on the image carrier 5 previously transferred onto the printing medium 7 before being transferred onto the printing medium 7 in the transfer area F. A re-transfer phenomenon occurs in a second electrical discharge occurring area S2 located downstream the transfer area F in the moving direction B of the printing medium. The re-transfer phenomenon represents some toner transferred onto the printing medium 7 that again moves back to the image carrier 5 due to the electrical discharge.

When the pre-transfer phenomenon or/and the re-transfer phenomenon occur in the transfer apparatus, the toner image on the image carrier 5 is not precisely transferred onto the printing medium 7 so that a transfer deficiency may occur. Therefore, the image forming apparatus using the transfer apparatus cannot provide a good print.

### SUMMARY OF THE INVENTION

The present general inventive concept provides a transfer apparatus to prevent a re-transfer phenomenon from occurring downstream a transfer area so that a transfer deficiency does not occur, and an image forming apparatus having the same.

Also, the present general inventive concept provides a transfer apparatus that can prevent a pre-transfer phenomenon and a re-transfer phenomenon from occurring upstream a transfer area and downstream the transfer area so that a transfer deficiency does not occur, and an image forming apparatus having the same.

Additional aspects and utilities of the present general inventive concept will be set forth in part in the description which follows and, in part, will be obvious from the description, or may be learned by practice of the general inventive concept.

The foregoing and/or other aspect and utilities of the present general inventive concept can substantially be achieved by providing a transfer apparatus usable with an image forming apparatus, which includes a transfer tube to face an image carrier, and a transfer roller disposed inside the transfer tube to cause the transfer tube to rotate.

The transfer tube may rotate to contact the image carrier to form a contact area including an area corresponding to at least a transfer area and a second electrical discharge occurring area downstream the transfer area between the image carrier and the transfer roller.

The transfer tube may form an aperture between the transfer roller and the transfer tube to continue to contact the image carrier.

The transfer apparatus may include a tube contacting roller disposed at one side of the transfer roller to cause a portion of the transfer tube upstream of the transfer area to contact the transfer roller.

The tube contacting roller may be disposed outside the second electrical discharge occurring area downstream of the transfer area so that an angle between a first straight line to join a center of the image carrier and a center of the transfer roller and a second straight line to join the center of the transfer roller and a center of the tube contacting roller is in a range of approximately 180° or less.

The tube contacting roller may be disposed so that an angle between a first straight line to join a center of the image carrier and a center of the transfer roller and a second straight line to join the center of the transfer roller and a center of the tube contacting roller is in a range of approximately 90° to 180°.

A linear velocity of an outer circumferential surface of the transfer roller may be faster than a linear velocity of an outer circumferential surface of the tube contacting roller.

The tube contacting roller may be driven by the transfer tube.

The foregoing and/or other aspects and utilities of the present general inventive concept can also be achieved by providing a transfer apparatus including a plurality of tube contacting rollers disposed around the transfer roller.

A first tube contacting roller disposed proximate to the transfer area in a rotation direction of the transfer roller among the plurality of tube contacting rollers may be disposed so that an angle between a first straight line to join a center of the image carrier and a center of the transfer roller and a second straight line to join the center of the transfer roller and a center of the first tube contacting roller is in a range of approximately 90° to 180°.

The transfer tube may have an electrical resistance of at least 10 E+6 ohms.

The transfer tube may be made of a resin selected from a group consisting of Polyvinyl Chloride (PC), Polyimide (PI), Polyamide (PA), Polyethylene Telephthalate (PET), and Polyamidoamine Epichlorohydrin (PAE).

A maximum thickness of the transfer tube may be approximately 2 mm.

The transfer tube may be made of a rubber selected from a group consisting of Nitril Butadiene Rubber (NBR), Styrene Butadiene Rubber (SBR), Chloroprene Rubber (CR), EFDM, Polyurethane, and Silicone.

A maximum thickness of the transfer tube may be approximately 5 mm.

A maximum circumferential length of the transfer tube may be twice a circumferential length of the transfer roller.

The transfer apparatus may include a printing medium contacting unit disposed at one side of the image carrier to guide a printing medium to contact the image carrier in front of a first electrical discharge occurring area upstream of a transfer area between the image carrier and the transfer roller.

The printing medium contacting unit may include a lower printing medium guide member disposed at one side of the image carrier to guide the printing medium, a printing medium guide roller disposed downstream the lower printing medium guide member, and an upper printing medium guide member disposed above the lower printing medium guide roller for a leading end thereof located above the printing medium guide roller.

The foregoing and/or other aspects and utilities of the present general inventive concept can also be achieved by providing an image forming apparatus including a printing medium supplying unit, a transfer apparatus to transfer an image onto a printing medium conveyed from the printing medium supplying unit, wherein the transfer apparatus includes a transfer tube to face an image carrier, and a transfer roller disposed inside the transfer tube to cause the transfer tube to rotate, and a fixing unit to fix the image transferred by the transfer apparatus onto the printing medium.

The foregoing and/or other aspects and utilities of the general inventive concept may also be achieved by providing an image forming apparatus including an image carrier having a transfer area, a first electrical discharge occurring area disposed upstream of the transfer area and a second electrical discharge occurring area disposed downstream of the transfer area; and a transfer tube to form and to contact a first contact area and a second contact area, wherein the first contact area includes an area corresponding to the transfer area and the first electrical discharge occurring area, and the second contact area includes an area corresponding to the transfer area and the second electrical discharge occurring area.

The foregoing and/or other aspects and utilities of the general inventive concept may also be achieved by providing a method of forming an image on a printing medium, the method including guiding the printing medium to contact an image carrier outside a first electrical discharge occurring area disposed upstream of a transfer area, moving the printing medium to the transfer area to transfer the image from the image carrier to the printing medium while covering a portion of the image carrier corresponding to the first electrical discharge occurring area, supporting the printing medium to contact the image carrier and to pass the printing medium through the second electrical discharge occurring area disposed downstream of the transfer area, and blocking the image carrier from a transfer roller downstream of the transfer area corresponding to the second electrical discharge occurring area.

### BRIEF DESCRIPTION OF THE DRAWINGS

These and/or other aspects and utilities of the present general inventive concept will become apparent and more readily appreciated from the following description of the embodiments, taken in conjunction with the accompanying drawings of which:

FIG. 1 is a sectional view schematically illustrating a conventional transfer apparatus;

FIG. 2 is a sectional view schematically illustrating a transfer apparatus according to an embodiment of the present general inventive concept;

FIG. 3 is an enlarged sectional view illustrating a portion of an image carrier and a transfer roller of FIG. 2 illustrated in circle D;

FIG. 4 is a sectional view schematically illustrating a transfer apparatus according to another embodiment of the present general inventive concept;

FIG. 5 is a sectional view illustrating an image forming apparatus having a transfer apparatus according to an embodiment of the present general inventive concept; and

FIG. 6 is a flowchart illustrating a method of forming an image on a printing medium according to an exemplary embodiment of the present general inventive concept.

### DETAILED DESCRIPTION OF THE PREFERRED EMBODIMENTS

Reference will now be made in detail to embodiments of the present general inventive concept, examples of which are illustrated in the accompanying drawings, wherein like reference numerals refer to the like elements throughout. The embodiments are described below in order to explain the present general inventive concept by referring to the figures.

The matters defined in the description, such as a detailed construction and elements thereof, are provided to assist in a comprehensive understanding of the present general inventive concept. Thus, it is apparent that the present inventive concept may be carried out without those defined matters. Also, well-known functions or constructions are omitted to provide a clear and concise description of exemplary embodiments herein.

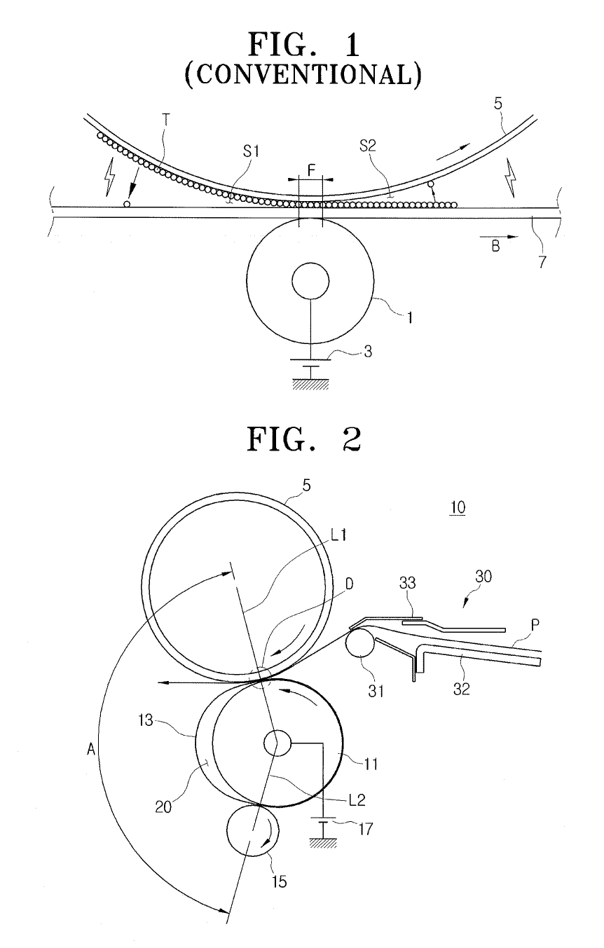

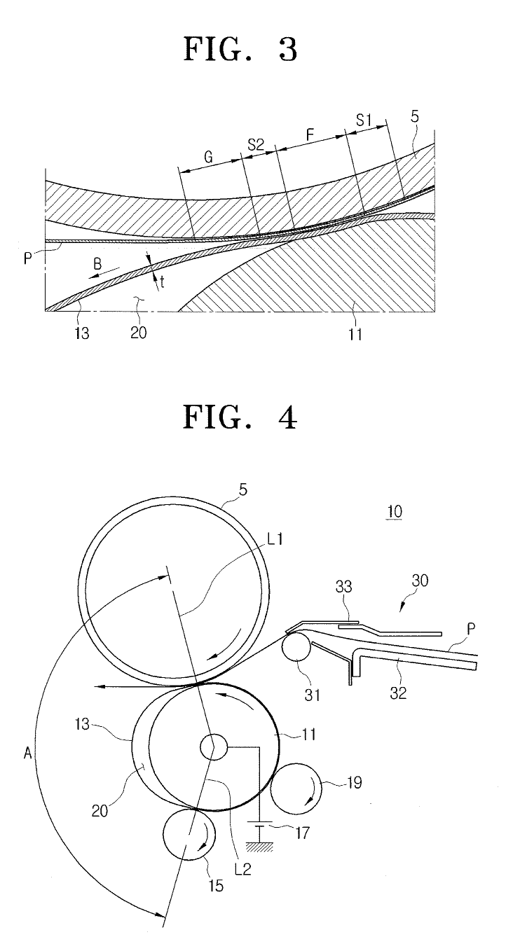

FIG. 2 is a sectional view schematically illustrating a transfer apparatus 10 according to an embodiment of the present general inventive concept, and FIG. 3 is an enlarged sectional view illustrating a portion between of an image carrier 5 and a transfer roller 11 of FIG. 2 illustrated in circle D.

Referring to FIG. 2, the transfer apparatus 10 for the image forming apparatus according to an embodiment of the present general inventive concept includes the transfer roller 11, a transfer tube 13, a tube contacting roller 15, and a printing medium contacting unit 30.

The transfer roller 11 is rotatably disposed under an image carrier 5 to cause the transfer tube 13 to rotate. The transfer roller 11 is made of a sponge or a rubber material. A transfer voltage applying portion 17 applies a high transfer voltage to the transfer roller 11 so that the transfer roller 11 causes a toner image on the image carrier 5 to be transferred onto a printing medium P passing between the transfer tube 13 and the image carrier 5.

The transfer voltage applying portion 17 applies a voltage with a polarity opposite to a polarity of toner to the transfer roller 11 so that the toner image on the image carrier 5 is transferred onto the printing medium P. When the toner has a negative polarity, the transfer voltage applying portion 17 generally applies a positive voltage of approximately 800˜2500 V to the transfer roller 11.

The transfer tube 13 prevents an electrical discharge from occurring between the transfer roller 11 and the image carrier 5, and is disposed to face the image carrier 5 and proximate to an outer circumferential surface of the transfer roller 11. That is, the transfer tube 13 is disposed between the image carrier 5 and the transfer roller 11 to contact both the image carrier 5 and the transfer roller 11. Therefore, the transfer tube 13 can rotate in a moving direction of the printing medium P by rotations of the transfer roller 11 and the image carrier 5.

As illustrated in FIG. 3, the transfer tube 13 to contact the image carrier 5 to form a contact area including an area to cover at least a transfer area F and a second electrical discharge occurring area S2 of the image carrier 5, or to force the printing medium P, which enters between the image carrier 5 and the transfer tube 13, to contact the image carrier 5 to form a contact area including an area to cover at least the transfer area F and the second electrical discharge occurring area S2 of the image carrier 5 prevents the electrical discharge from occurring between the transfer roller 11 and the image carrier 5. That is, the transfer tube 13 prevents the printing medium P from being separated from the image carrier 5 right after the printing medium P passes the transfer area F in the moving direction of the printing medium P. Accordingly, first and second electrical discharge occurring areas S1 and S2 represent areas in which a pre-transfer phenomenon and a re-transfer phenomenon occur due to the electrical discharge generated between the image carrier 5 and the transfer roller 11, when the transfer tube 13 is not disposed between the image carrier 5 and the transfer roller 11 as a conventional transfer apparatus.

The transfer tube 13 has a circumferential length longer than that of the transfer roller 11 so that the transfer tube 13 can support the printing medium P and allow the printing medium P to be separated from the image carrier 5 after the printing medium P passes the second electrical discharge occurring area S2 of the image carrier 5. Furthermore, the circumferential length of the transfer tube 13 may not be over twice the circumferential length of the transfer roller 11 so that the transfer tube 13 is stably driven.

In addition, the transfer tube 13 has a high electrical resistance to effectively prevent the electrical discharge between the image carrier 5 and the transfer roller 11. When the transfer tube 13 has a low electrical resistance, an electrical field is formed along a surface of the transfer tube 13 so that the second electrical discharge occurring area S2 is widened. If the second electrical discharge occurring area S2 is wider than a printing medium separating area G, the transfer tube 13 cannot remove the re-transfer phenomenon. Accordingly, the printing medium separating area G represents an area in which the printing medium P is separated from the image carrier 5 as illustrated in FIG. 3.

The transfer tube 13 may be made of a material having the electrical resistance of approximately 10 E+6Ω or more. That is, the transfer tube 13 may be made of one resin selected among Polyvinyl Chloride (PC), Polyimide (PI), Polyamide (PA), Polyethylene Telephthalate (PET), Polyamidoamine Epichlorohydrin (PAE), etc. Also, the transfer tube 13 may be made of one rubber selected among Nitril Butadiene Rubber (NBR), Styrene Butadiene Rubber (SBR), Chloroprene Rubber (CR), EFDM, Polyurethane, Silicone, etc.

In addition, as a thickness t of the transfer tube 13 is thicker, a transfer efficiency is decreased. Therefore, the transfer tube 13 has a thin thickness. When the transfer tube 13 is made of a resin, the transfer tube 13 may have the thickness t of approximately 2 mm or less to maintain a proper transfer efficiency. When the transfer tube 13 is made of a rubber, the transfer tube 13 may have the thickness t of approximately 5 mm or less to maintain the proper transfer efficiency.

Referring to FIGS. 3 and 4, the tube contacting roller 15 forces the transfer tube 13 to contact the transfer roller 11 and to rotate along with the transfer roller 11, and is rotatably disposed at one side of the transfer roller 11. Therefore, the transfer tube 13 is disposed between the tube contacting roller 15 and the transfer roller 11. The tube contacting roller 15 causes an aperture 20 to be formed between the transfer tube 13 and the transfer roller 11 as illustrated in FIG. 2 so that the transfer tube 13 contacts the image carrier 5 to a predetermined distance behind the transfer area F, that is, downstream the transfer area F in the moving direction B of the printing medium P. Also, the tube contacting roller 15 causes a portion of the transfer tube 13 upstream of the transfer area F to the tube contacting roller 15 to closely contact the transfer roller 11 so that the transfer tube 13 is allowed to smoothly rotate along with the transfer roller 11. While the transfer roller 11 rotates, the aperture 20 formed between the transfer tube 13 and the transfer roller 11 may maintain uniform size and shape downstream of the transfer area F in the moving direction B of the printing medium P.

In order to uniformly maintain the aperture 20 of the transfer tube 13, the tube contacting roller 15 may be disposed behind the transfer area F in the moving direction B of the printing medium P from a first straight line L1 to join a center of the image carrier 5 and a center of the transfer roller 11 as illustrated in FIG. 2. When an angle between the first straight line L1 to join the center of the image carrier 5 and the center of the transfer roller 11 and a second straight line L2 to join the center of the transfer roller 11 and a center of the tube contacting roller 15, that is, a disposing angle of the tube contacting roller 15 refers to A, the tube contacting roller 15 may be disposed so that the disposing angle A is approximately 90˜180°. When the disposing angle A of the tube contacting roller 15 is less than approximately 90°, a tension of the transfer tube 13 may cause the transfer tube 13 to be damaged or crumpled. When the disposing angle A of the tube contacting roller 15 is more than approximately 180°, the transfer tube 13 cannot have a sufficient contacting distance in which the transfer tube 13 closely contacts the transfer roller 11.

In addition, a linear velocity of an outer circumferential surface of the tube contacting roller 15 may be slower than a linear velocity of the outer circumferential surface of the transfer roller 11 so that the aperture 20 of the transfer tube 13 can always be downstream of the transfer area F in the moving direction B of the printing medium P. That is, if the transfer roller 11 and the tube contacting roller 15 rotate, and Vtr>Vr is satisfied, the aperture 20 of the transfer tube 13 can always be downstream the transfer area F in the moving direction B of the printing medium P. Here, Vtr is the linear velocity of the outer circumferential surface of the transfer roller 11, and Vr is the linear velocity of the outer circumferential surface of the tube contacting roller 15.

The tube contacting roller 15 may be disposed to be rotated by a friction force between the tube contacting roller 15 and the transfer tube 13, that is, may be driven by the transfer tube 13. Alternatively, the tube contacting roller 15 is structured to be rotated by a separate driving source (not illustrated).

Also, the transfer apparatus 10 according to an embodiment of the present general inventive concept may have two or more tube contacting rollers 15 and 19, that is, a plurality of tube contacting rollers as illustrated in FIG. 4. Accordingly, the first tube contacting roller 15, which is disposed proximate to the transfer area F in a rotation direction of the transfer roller 11 among the plurality of tube contacting rollers 15 and 19, may have the disposing angle A of approximately 90˜180°. If the plurality of tube contacting rollers 15 and 19 is disposed around the transfer roller 11, the transfer tube 13 is driven more stably and the printing medium separating area G is wider than one tube contacting roller 15 is disposed around the transfer roller 11.

The printing medium contacting unit 30 guides the printing medium P to contact the image carrier 5 before the printing medium P arrives at the transfer area F, and includes a printing medium guide roller 31 and upper and lower printing medium guide members 33 and 32.

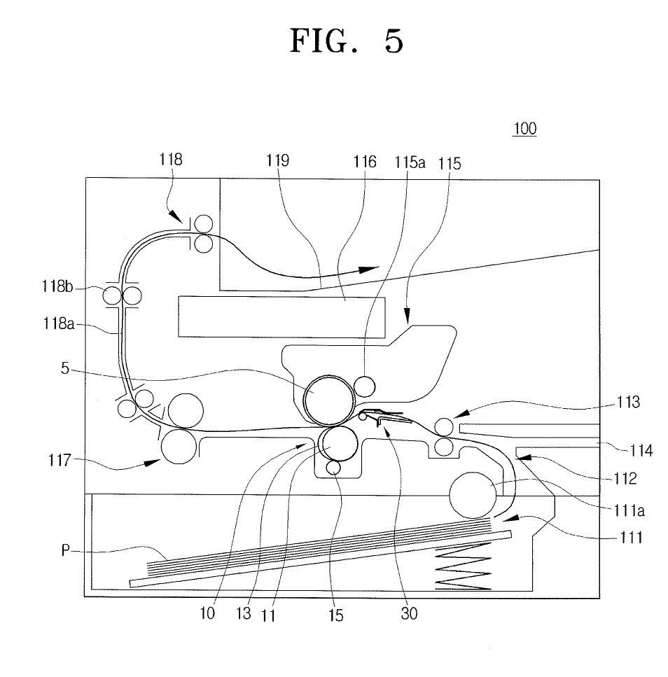

The lower printing medium guide member 32 guides the printing medium P conveyed from the printing medium supplying unit 111 (see FIG. 5) toward the printing medium guide roller 31. The printing medium guide roller 31 is disposed adjacent to the lower printing medium guide member 32 and downstream the lower printing medium guide member 32. The upper printing medium guide member 33 is disposed to space apart from the lower printing medium guide member 32 above the lower printing medium guide member 32. A leading end of the upper printing medium guide member 33 locates above the printing medium guide roller 31. The upper printing medium guide member 33 and the printing medium guide roller 31 may guide the printing medium P so that a leading end of the printing medium P passing between the upper and lower printing medium guide members 33 and 32 contacts the image carrier 5 outside the transfer area F of the image carrier 5, for example, outside the first electrical discharge occurring area S1 upstream of the transfer area F.

Therefore, the printing medium P passing through the printing medium contacting unit 30 contacts image carrier 5 outside the transfer area F, and then, enters the transfer area F. When the printing medium P contacts the image carrier 5 outside the transfer area F, that is, outside the first electrical discharge occurring area S1, the pre-transfer phenomenon does not occur.

Hereinafter, operation of the transfer apparatus 10 for the image forming apparatus according to an embodiment of the present general inventive concept will be explained with reference to FIGS. 2 and 3.

The printing medium P fed from the printing medium supplying unit 111 (see FIG. 5) enters the printing medium contacting unit 30. The printing medium P to enter the printing medium contacting unit 30 moves to the printing medium guide roller 31 along the upper and lower printing medium guide members 33 and 32.

The leading end of the printing medium P passing the printing medium guide roller 31 contacts the image carrier 5 outside the first electrical discharge occurring area S1 upstream of the transfer area F, and then, moves toward the transfer area F by the leading end of the upper printing medium guide member 33 and the printing medium guide roller 31.

Then, the printing medium P moves to the transfer area F while covering a portion of the image carrier 5 that corresponds to the first electrical discharge occurring area S1 upstream of the transfer area F so that electrical discharge does not occur between the image carrier 5 and the transfer roller 11. As a result, the pre-transfer phenomenon that causes some toner of the toner image on the image carrier 5 to be transferred onto the printing medium P outside the transfer area F by the electrical discharge between the image carrier 5 and the transfer roller 11 may not occur.

When the printing medium P passes through the transfer area F between the image carrier 5 and the transfer roller 11, the toner image on the image carrier 5 is transferred onto the printing medium P due to the transfer voltage applied to the transfer roller 11.

After the printing medium P passed the transfer area F, the transfer tube 13, as illustrated in FIG. 3, supports the printing medium P to contact the image carrier 5 and pass through the second electrical discharge occurring area S2 downstream of the transfer area F. At this time, the transfer tube 13 has the circumferential length longer than that of the transfer roller 11 so that the aperture 20 is formed between the transfer tube 13 and the transfer roller 11. Also, the linear velocity of the outer circumferential surface of the tube contacting roller 15 is slower than that of the transfer roller 11 so that the aperture 20 of the transfer tube 13 is formed downstream the transfer area F. As a result, the transfer tube 13 supports the printing medium P to continue to contact the image carrier 5 outside of the transfer area F.

After the printing medium P passes through the second electrical discharge occurring area S2 of the image carrier 5 downstream the transfer area F, the printing medium P is separated from the image carrier 5 at the printing medium separating area G.

In the transfer apparatus 10 for the image forming apparatus according to an embodiment of the present general inventive concept, the transfer tube 13 blocks the image carrier 5 from the transfer roller 11 downstream of the transfer area F so that the electrical discharge does not occur between the image carrier 5 and the transfer roller 11 downstream of the transfer area F. As a result, the re-transfer phenomenon does not occur downstream of the transfer area F.

FIG. 5 is a sectional view schematically illustrating an image forming apparatus 100 using the transfer apparatus 10 according to an embodiment of the present general inventive concept.

Referring to FIG. 5, the image forming apparatus 100 having the transfer apparatus according to an embodiment of the present general inventive concept includes the printing medium supplying unit 111, a feed roller 113, a developing unit 115, the transfer apparatus 10, a fixing unit 117, and a discharging unit 118.

The printing medium supplying unit 111 is disposed at a lowermost portion of the image forming apparatus 100, and includes a pickup roller 111a to supply the printing medium P one by one. A movement guide member 112 is disposed between the printing medium supplying unit 111 and the feed roller 113 to divert a path of the printing medium P so that the printing medium P is supplied to the feed roller 113. A supplementary printing medium supplying unit 114 is disposed at one side of the feed roller 113 to supply another type of printing medium such as an envelope.

The developing unit 115 is disposed at one side of the feed roller 113, and includes the image carrier 5 on which an electrostatic latent image corresponding to printing data is formed and a developing roller 115a to supply toner to the image carrier 5 so as to develop the electrostatic latent image into a toner image.

A light exposure unit 116 is disposed above the developing unit 115 to emit a light corresponding to the printing data to the image carrier 5 to form the electrostatic latent image.

The transfer apparatus 10 is disposed below the developing unit 115, and causes the toner image formed on the image carrier 5 of the developing unit 115 to be transferred onto the printing medium P. The printing medium contacting unit 30 is disposed upstream of the transfer apparatus 10 to guide the printing medium P conveyed by the feed roller 113 to contact the image carrier 5 outside the transfer area F. The transfer apparatus 10 and the printing medium contacting unit 30 are described above; therefore, descriptions thereof are not repeated.

The fixing unit 117 is disposed at one side of the transfer apparatus 10, and applies high heat and high pressure to the printing medium P so as to fix the toner image onto the printing medium P.

The discharging unit 118 is disposed above the fixing unit 117. The printing medium P discharged from the discharging unit 118 is loaded on a printing medium loading portion 119 disposed above the light exposure unit 116. The discharging unit 118 includes a discharging guide member 118a and a plurality of discharging rollers 118b to divert the course of the printing medium P and convey the printing medium P so that the printing medium P passed through the fixing unit 117 can be discharged to the printing medium loading portion 119.

Therefore, the printing medium P loaded in the printing medium supplying unit 111 is picked up one by one by the pickup roller 111a. The movement guide member 112 diverts the path of the picked up printing medium P, and conveys the printing medium P to the feed roller 113. The feed roller 113 conveys the printing medium P between the image carrier 5 of the developing unit 115 and the transfer tube 13 of the transfer apparatus 10. At this time, the light exposure unit 116 forms an electrostatic latent image corresponding to the printing data on the image carrier 5 of the developing unit 115, and the developing roller 115a develops the electrostatic latent image with toner to form a toner image.

The toner image formed on the image carrier 5 of the developing unit 115 is transferred onto the printing medium P to pass between the image carrier 5 and the transfer tube 13 by the feed roller 113. At this time, the printing medium contacting unit 30 forces the printing medium P to contact the image carrier 5 outside the first electrical discharge occurring area S1 upstream of the transfer area F, and then, move to the transfer area F so that the pre-transfer phenomenon caused by the electrical discharge between the image carrier 5 and the transfer roller 11 does not occur.

Furthermore, after passing the transfer area F, the printing medium P is conveyed to the outside of the second electrical discharge occurring area S2 of the downstream of the transfer area F while contacting the image carrier 5 by the transfer tube 13, and then, separated from the image carrier 5. As a result, downstream of the transfer area F the re-transfer phenomenon caused by the electrical discharge between the image carrier 5 and the transfer roller 11 does not occur.

When the printing medium P having the toner image transferred thereon passes the fixing unit 117, the toner image is fixed onto the printing medium P. The printing medium P having the image fixed thereon is discharged to the printing medium loading portion 119 by the discharging guide member 118a and the plurality of discharging rollers 118b of the discharging unit 118, thereby completing a print.

In the above-description, the transfer apparatus 10 is disposed below the image carrier 5; however, this should not be considered as limiting. Alternatively, the transfer apparatus 10 according to an embodiment of the present general inventive concept may be disposed above the image carrier 5.

Additionally, in the above-description, the transfer apparatus 10 is used to the image carrier 5 having a cylindrical shape such as a photosensitive drum; however, this should not be considered as limiting. Alternatively, the transfer apparatus 10 according to an embodiment of the present general inventive concept may be used to the image carrier 5 such as a belt-type photosensitive medium.

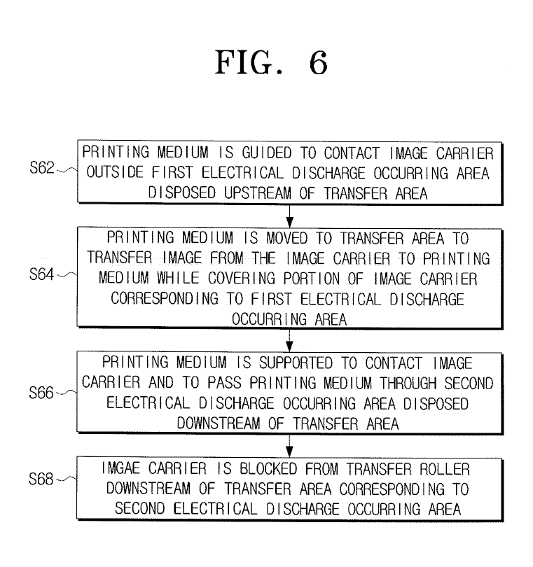

FIG. 6 is a flowchart illustrating a method of forming an image on a printing medium according to an exemplary embodiment of the present general inventive concept. Referring to FIG. 6, in operation S62, a printing medium is guided to contact an image carrier outside a first electrical discharge occurring area disposed upstream of a transfer area. In operation S64, the printing medium is moved to the transfer area to transfer an image from the image carrier to the printing medium while covering a portion of the image carrier corresponding to the first electrical discharge occurring area. In operation S66, the printing medium is supported to contact the image carrier and to pass the printing medium through the second electrical discharge occurring area disposed downstream of the transfer area. In operation S68, the image carrier is blocked from a transfer roller downstream of the transfer area corresponding to the second electrical discharge occurring area.

The present general inventive concept can also be embodied as computer-readable codes on a computer-readable medium. The computer-readable medium can include a computer-readable recording medium and a computer-readable transmission medium. The computer-readable recording medium is any data storage device that can store data that can be thereafter read by a computer system. Examples of the computer-readable recording medium include read-only memory (ROM), random-access memory (RAM), CD-ROMs, magnetic tapes, floppy disks, and optical data storage devices. The computer-readable recording medium can also be distributed over network coupled computer systems so that the computer-readable code is stored and executed in a distributed fashion. The computer-readable transmission medium can transmit carrier waves or signals (e.g., wired or wireless data transmission through the Internet). Also, functional programs, codes, and code segments to accomplish the present general inventive concept can be easily construed by programmers skilled in the art to which the present general inventive concept pertains.

With the transfer apparatus for the image forming apparatus according to various embodiments of the present general inventive concept, the transfer tube of the transfer apparatus prevents the electrical discharge from occurring between the image carrier and the transfer roller downstream the transfer area so that the re-transfer phenomenon does not occur. As a result, in the transfer apparatus according to an embodiment of the present general inventive concept, a transfer deficiency caused by the re-transfer phenomenon does not occur.

Also, with the image forming apparatus having the transfer apparatus according to various embodiments of the present general inventive concept, the transfer tube of the transfer apparatus prevents the electrical discharge downstream of the transfer area, and the printing medium contacting unit prevents the electrical discharge upstream of the transfer area so that the pre-transfer and re-transfer phenomenon does not occur. As a result, in the image forming apparatus according to an embodiment of the present general inventive concept, the transfer deficiency caused by the pre-transfer and re-transfer phenomenon does not occur. Although various embodiments of the present general inventive concept have been illustrated and described, it will be appreciated by those skilled in the art that changes may be made in these embodiments without departing from the principles and spirit of the general inventive concept, the scope of which is defined in the appended claims and their equivalents.

What is claimed is:

1. A transfer apparatus usable with an image forming apparatus, the transfer apparatus comprising:
a transfer tube to face an image carrier; and
a transfer roller disposed inside the transfer tube to cause the transfer tube to rotate.

2. The transfer apparatus of claim 1, wherein the transfer tube rotates to contact the image carrier to form a contact area including an area corresponding to at least a transfer area and a second electrical discharge occurring area downstream of the transfer area between the image carrier and the transfer roller.

3. The transfer apparatus of claim 2, wherein the transfer tube forms an aperture between the transfer roller and the transfer tube to continue to contact the image carrier.

4. The transfer apparatus of claim 3, further comprising:
a tube contacting roller disposed at one side of the transfer roller to cause a portion of the transfer tube upstream of the transfer area to contact the transfer roller.

5. The transfer apparatus of claim 4, wherein the tube contacting roller is disposed outside the second electrical discharge occurring area downstream of the transfer area so that an angle between a first straight line to join a center of the image carrier and a center of the transfer roller and a second straight line to join the center of the transfer roller and a center of the tube contacting roller is in a range of approximately 180° or less.

6. The transfer apparatus of claim 4, wherein the tube contacting roller is disposed so that an angle between a first straight line to join a center of the image carrier and a center of the transfer roller and a second straight line to join the center of the transfer roller and a center of the tube contacting roller is in a range of approximately 90° to 180°.

7. The transfer apparatus of claim 4, wherein a linear velocity of an outer circumferential surface of the transfer roller is faster than a linear velocity of an outer circumferential surface of the tube contacting roller.

8. The transfer apparatus of claim 7, wherein the tube contacting roller is driven by the transfer tube.

9. The transfer apparatus of claim 4, wherein the tube contacting roller comprises:
a plurality of tube contacting rollers disposed around the transfer roller.

10. The transfer apparatus of claim 9, wherein a first tube contacting roller disposed proximate to the transfer area in a rotation direction of the transfer roller among the plurality of tube contacting rollers is disposed so that an angle between a first straight line to join a center of the image carrier and a center of the transfer roller and a second straight line to join the center of the transfer roller and a center of the first tube contacting roller is in a range of approximately 90° to 180°.

11. The transfer apparatus of claim 1, wherein the transfer tube has an electrical resistance of at least 10 E+6 ohms.

12. The transfer apparatus of claim 11, wherein the transfer tube is made of a resin selected from a group consisting of Polyvinyl Chloride (PC), Polyimide (PI), Polyamide (PA), Polyethylene Telephthalate (PET), and Polyamidoamine Epichlorohydrin (PAE).

13. The transfer apparatus of claim 12, wherein a maximum thickness of the transfer tube is approximately 2 mm.

14. The transfer apparatus of claim 11, wherein the transfer tube is made of a rubber selected from a group consisting of Nitril Butadiene Rubber (NBR), Styrene Butadiene Rubber (SBR), Chloroprene Rubber (CR), EFDM, Polyurethane, and Silicone.

15. The transfer apparatus of claim 14, wherein a maximum thickness of the transfer tube is approximately 5 mm.

16. The transfer apparatus of claim 1, wherein a maximum circumferential length of the transfer tube is twice a circumferential length of the transfer roller.

17. The transfer apparatus of claim 1, further comprising:
a printing medium contacting unit disposed at one side of the image carrier to guide a printing medium to contact the image carrier in front of a first electrical discharge occurring area upstream of a transfer area between the image carrier and the transfer roller.

18. The transfer apparatus of claim 17, wherein the printing medium contacting unit comprises:
a lower printing medium guide member disposed at one side of the image carrier to guide the printing medium;
a printing medium guide roller disposed downstream the lower printing medium guide member; and
an upper printing medium guide member disposed above the lower printing medium guide roller for a leading end thereof located above the printing medium guide roller.

19. An image forming apparatus, comprising:
a printing medium supplying unit;
a transfer apparatus to transfer an image onto a printing medium conveyed from the printing medium supplying unit, wherein the transfer apparatus comprises:
a transfer tube to face an image carrier, and
a transfer roller disposed inside the transfer tube to cause the transfer tube to rotate; and
a fixing unit to fix the image transferred by the transfer apparatus onto the printing medium.

20. The image forming apparatus of claim 19, wherein the transfer tube rotates to contact the image carrier forming a contact area including an area corresponding to at least a transfer area and a second electrical discharge occurring area downstream of the transfer area between the image carrier and the transfer roller.

21. The image forming apparatus of claim 20, wherein the transfer apparatus further comprises:
a tube contacting roller disposed at one side of the transfer roller to cause a portion of the transfer tube upstream of the transfer area to be contacted to the transfer roller.

22. The image forming apparatus of claim 21, wherein a linear velocity of an outer circumferential surface of the transfer roller is faster than a linear velocity of an outer circumferential surface of the tube contacting roller.

23. The image forming apparatus of claim 19, wherein a maximum circumferential length of the transfer tube is twice a circumferential length of the transfer roller.

24. An image forming apparatus, comprising:
an image carrier having a transfer area, a first electrical discharge occurring area disposed upstream of the transfer area and a second electrical discharge occurring area disposed downstream of the transfer area; and
a transfer tube to form and to contact a first contact area and a second contact area,
wherein the first contact area includes an area corresponding to the transfer area and the first electrical discharge occurring area, and the second contact includes an area corresponding to the transfer area and the second electrical discharge occurring area.

25. A method of forming an image on a printing medium, the method comprising:
guiding the printing medium to contact an image carrier outside a first electrical discharge occurring area disposed upstream of a transfer area;
moving the printing medium to the transfer area to transfer the image from the image carrier to the printing medium while covering a portion of the image carrier corresponding to the first electrical discharge occurring area;
supporting the printing medium to contact the image carrier and to pass the printing medium through the second electrical discharge occurring area disposed downstream of the transfer area; and
blocking the image carrier from a transfer roller downstream of the transfer area corresponding to the second electrical discharge occurring area.
